(19) United States
(12) Patent Application Publication
(10) Pub. No.: US 2011/0122147 A1
(43) Pub. Date: May 26, 2011

(54) Image Display Apparatus Capable of Simultaneously Displaying Plurality of Images

(75) Inventors: Kei YASUKAWA, Osaka (JP); Kenji OHFUNE, Osaka (JP)

(73) Assignee: Sanyo Electric Co., Ltd., Osaka (JP)

(21) Appl. No.: 12/954,502

(22) Filed: Nov. 24, 2010

(30) Foreign Application Priority Data
Nov. 25, 2009 (JP) 2009-267375 P

(51) Int. Cl. G09G 5/02; G09G 5/00

(52) U.S. Cl. 345/589; 345/635

(57) ABSTRACT

When a dual-screen display mode is performed, two images based on two image signals, respectively, are simultaneously displayed in display regions of a display unit. If a presenter desires viewers to focus attention on one of the two images, a projector differentiates display manners of the images to be displayed, between one display region and the other display region. For example, if the presenter desires the viewers to focus attention on one image, the projector performs image processing for causing the other image to be displayed in an unhighlighted manner. As the image processing on this occasion, if the two images are both color images, the projector converts only the other image from the color image to a monochrome image.

This nonprovisional application is based on Japanese Patent Application No. 2009-267375 filed on Nov. 25, 2009 with the Japan Patent Office, the entire contents of which are hereby incorporated by reference.

### BACKGROUND OF THE INVENTION

1. Field of the Invention

The present invention relates to an image display apparatus, and more particularly, to an image display apparatus capable of simultaneously displaying a plurality of images.

2. Description of the Related Art

In recent years, an image display apparatus tends to include plural types of input terminals, and various image sources (external image equipment) can be connected thereto. In a case where a plurality of image signals are input from a plurality of image sources to the image display apparatus, a user can switch between a single-screen display state in which an image based on one of the plurality of image signals is singularly displayed on a substantially entire screen and a plural-screen display state in which a plurality of images based on the plurality of image signals, respectively, are displayed within one screen.

When the user makes a presentation using such an image display apparatus, and explains each of a plurality of images based on a plurality of image signals simultaneously displayed within a projection screen, there are often scenes where the user desires viewers to focus attention on one of the plurality of images. In such a scene, generally, the user provides an explanation while pointing to a desired image on the projection screen on which the plurality of images are projected, with a laser pointer utilizing a visible-light laser beam or a pointing bar.

Further, in an image display system capable of performing plural-screen display (multi-screen display) in which a plurality of projectors are connected to one personal computer to display plural types of images on a plurality of display screens, respectively, within a large-sized projection screen, if a selection manipulation to select not less than one of the display screens, an image display apparatus displaying an image on the display screen selected by the selection manipulation is caused to display the display screen in a highlighted manner.

However, in a conventional image display apparatus, in a scene where the user actually makes a presentation in the plural-screen display state as described above, the user has to manipulate an image source to turn a page of images and the like while showing a pointer with a laser pointer, which causes a problem of degradation in usability of the image display apparatus.

There has also been a problem that, when a position pointed to with a laser pointer deviates from a desired image due to influence of hand jiggling, the viewers feel it difficult to understand which image is being explained.

### SUMMARY OF THE INVENTION

According to an aspect of the present invention, an image display apparatus which displays an image based on an image signal includes an input unit to which a plurality of image signals are input from a plurality of image signal supply apparatuses, a display unit which displays a plurality of images based on the plurality of image signals, respectively, in a plurality of display regions, respectively, and a control unit which controls the display unit, when not less than one display region is selected from among the plurality of display regions, such that display manners of the images to be displayed are differentiated between the selected display region and a remaining display region of the plurality of display regions other than the selected display region.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view illustrating a configuration of peripheral apparatuses when, an image is projected by an image display apparatus in accordance with the present embodiment 1.

FIG. 2 is a view illustrating a configuration of a projector in FIG. 1.

FIG. 3 is a view illustrating an example of display images displayed by the projector when a dual-screen display mode is performed.

FIG. 4 is a flowchart for illustrating an operation of the projector.

FIG. 5 is a view illustrating an example of the display images in a state where an image 2 is displayed in an unhighlighted manner.

FIG. 6 is a view illustrating another example of the display images in the state where image 2 is displayed in an unhighlighted manner.

FIG. 7 is a view illustrating another example of the display images in the state where image 2 is displayed in an unhighlighted manner.

FIG. 8 is a flowchart for illustrating an operation of a projector in accordance with Embodiment 2 of the present invention.

FIG. 9 is a view illustrating an example of the display images in a state where an image 1 is displayed in a highlighted manner.

FIG. 10 is a view illustrating another example of the display images in the state where image 1 is displayed in a highlighted manner.

FIG. 11 is a flowchart for illustrating an operation of a projector in accordance with Embodiment 3 of the present invention.

FIG. 12 is a view illustrating an example of the display images in a state where image 1 is displayed in a highlighted manner.

### DESCRIPTION OF THE PREFERRED EMBODIMENTS

Hereinafter, embodiments of the present invention will be described in detail with reference to the drawings, in which identical or corresponding parts will be designated by the same reference numerals, and the description thereof will not be repeated.

### Embodiment 1

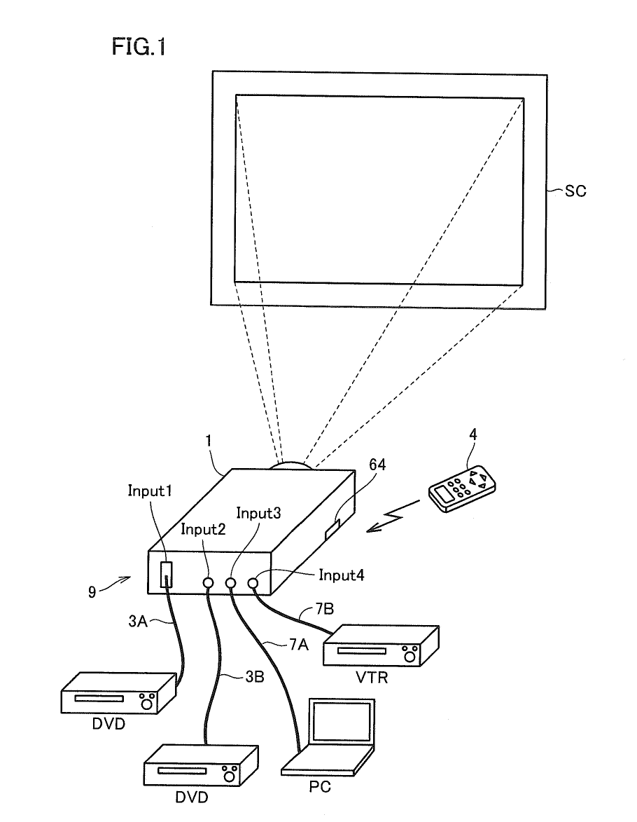

FIG. 1 is a view illustrating a configuration of peripheral apparatuses when an image is projected by an image display apparatus in accordance with the present embodiment 1.

Referring to FIG. 1, an image display apparatus (hereinafter also referred to as a “projector”) 1 in accordance with the present embodiment 1 is a liquid crystal projector projecting an image utilizing a liquid crystal device, and projects (displays) the image by projecting light of the image to be displayed by the liquid crystal device on a projection screen SC. A projection surface is not limited to projection screen SC, and may be a wall surface.

Projector 1 includes a manipulation accepting unit 64 receiving an infrared modulated remote control signal transmitted from a remote controller 4 manipulated by a user, and an input unit 9. The remote control signal includes a command signal for remotely controlling projector 1.

Manipulation accepting unit 64 can not only receive the remote control signal but also accept a signal from a manipulation unit (not shown) having a plurality of manipulation buttons for manipulating projector 1 provided to a main body of projector 1.

Input unit 9 includes a plurality of input terminals, and different types of image signals can be input from the input terminals. In the present embodiment, as an example, it is assumed that input unit 9 includes four input terminals Input 1 to Input 4.

A digital transmission path and an analog transmission path are connected to input unit 9. The digital transmission path includes a communication cable 3A conforming to the DVI (Digital Visual Interface) and a communication cable 3B conforming to the HDMI (High Definition Multimedia Interface).

Communication cable 3A is connected to input terminal Input 1 of input unit 9, and transmits an image signal between an external image source and projector 1 in accordance with the DVI. Examples of an apparatus (the image source) supplying an image signal in accordance with the DVI specification (hereinafter also referred to as a DVI signal) include an image source outputting a digital signal, such as a DVD (Digital Versatile Disc) reproduction apparatus and a Blu-Ray disc reproduction apparatus.

Communication cable 3B is connected to input terminal Input 2 of input unit 9, and transmits an image signal between an external image source and projector 1 in accordance with the HDMI. Examples of the image source supplying an image signal in accordance with the HDMI specification (hereinafter also referred to as an HDMI signal) include an image source outputting a digital signal, such as a DVD reproduction apparatus and a Blu-Ray disc reproduction apparatus.

The analog transmission path includes a plurality of wired or wireless transmission paths 7A, 7B. The transmission paths each transmit a signal between an image source and projector 1. Examples of the image source include an image source outputting an analog signal, such as a PC (Personal Computer) and a VTR (Videotape Recorder).

Input terminal Input 3 is an RGB terminal, and corresponds to an RGB analog signal supplied from the PC. Input terminal Input 4 is, for example, a video terminal, and corresponds to a video signal supplied from the VTR.

For simplicity of explanation, it is assumed that a signal transmitted from each image source is an image signal. Although an audio signal is also transmitted together with the image signal, transmission of the audio signal and audio signal processing in projector 1 will not be described for simplicity of explanation.

(Configuration of Projector)

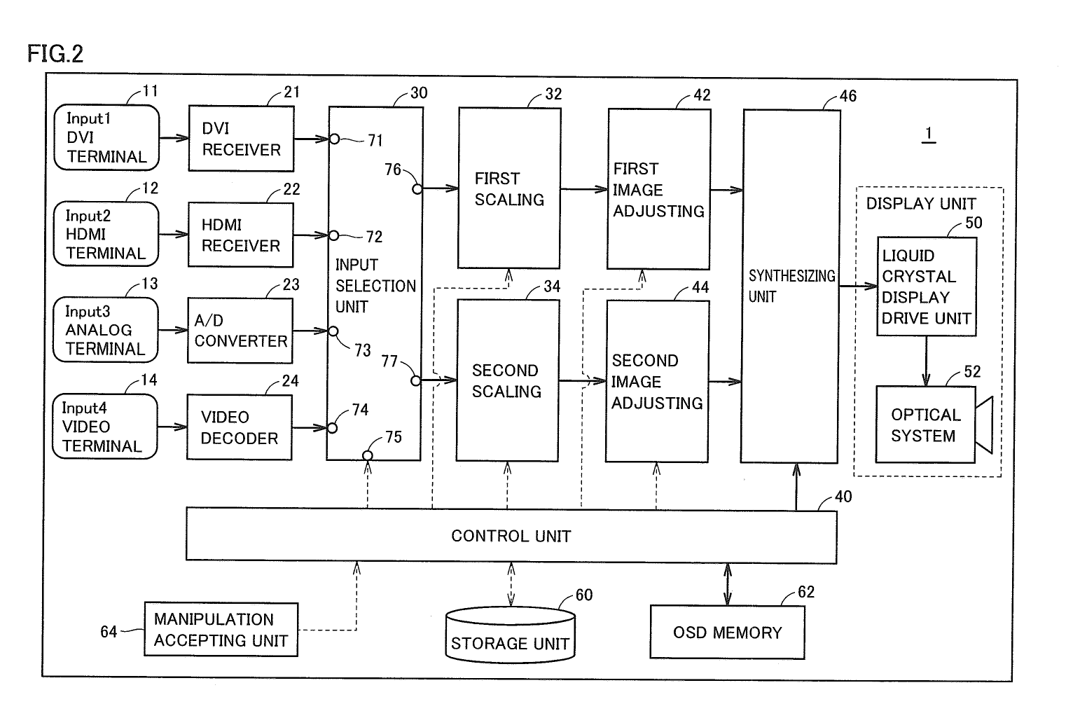

FIG. 2 is a view illustrating a configuration of projector 1 in FIG. 1.

Referring to FIG. 2, projector 1 includes input terminals 11 to 14, a DVI receiver 21, an HDMI receiver 22, an A/D converter 23, a video decoder 24, an input selection unit 30, scaling units 32, 34, image adjusting units 42, 44, a synthesizing unit 46, a liquid crystal display drive unit 50, an optical system 52, a control unit 40, a storage unit 60, an OSD (On Screen Display) memory 62, and manipulation accepting unit 64.

Input terminals 11 to 14 correspond to input terminals Input 1 to Input 4 of input unit 9 shown in FIG. 1, respectively. Input terminal 11 corresponds to input terminal Input 1 (a DVI terminal), input terminal 12 corresponds to input terminal Input 2 (an HDMI terminal), input terminal 13 corresponds to input terminal Input 3 (the RGB terminal), and input terminal 14 corresponds to input terminal Input 4 (the video terminal).

DVI receiver 21 receives and processes a digital image signal (DVI signal) received at input terminal 11, and outputs the processed signal to input selection unit 30. Specifically, DVI receiver 21 has an authentication function and a decryption function in accordance with the HDCP (High-bandwidth Digital Content Protection). The HDCP is used to implement encryption of data transmitted in accordance with the DVI. This can prevent illegal copying of a content such as an image signal transmitted over the digital transmission path.

To protect transmission data and signals by the HDCP, firstly, a transmission side (the DVD reproduction apparatus) bilaterally communicates with a reception side (projector 1) to exchange information for mutual authentication. Based on the information, the transmission side authenticates the reception side. If the transmission side can authenticate the reception side as a result of the authentication, the transmission side encrypts a digital image signal using a key commonly owned beforehand, and transmits the encrypted digital image signal to the reception side via the digital transmission path. The reception side decrypts the encryption using the key shared beforehand. If the transmission side cannot authenticate the reception side, the transmission side rejects transmission of a digital image signal to the reception side, and the image signal is not transmitted to the reception side.

HDMI receiver 22 receives and processes an HDMI signal received at input terminal 12, and outputs the processed signal to input selection unit 30. HDMI receiver 22 has an authentication function and a decryption function in accordance with the HDCP, as with DVI receiver 21 described above.

A/D converter 23 performs A/D conversion on an RGB analog image signal received at input terminal 13, and outputs it as a digital image signal to input selection unit 30. This is performed to subject the image signal to various signal processing.

Video decoder 24 converts a received video signal into a component signal, and then performs image signal processing including A/D conversion processing on the component signal. Video decoder 24 outputs the processed signal to input selection unit 30.

Input selection unit 30 includes a first input portion 71 receiving the DVI signal output from DVI receiver 21, a second input portion 72 receiving the HDMI signal output from HDMI receiver 22, a third input portion 73 receiving the RGB analog signal output from A/D converter 23, and a fourth input portion 74 receiving the video signal output from video decoder 24. Further, input selection unit 30 includes a switching input portion 75 receiving a switching signal supplied from control unit 40, a first output terminal 76 to which the first scaling unit 32 is connected, and a second output terminal 77 to which the second scaling unit 34 is connected.

Input selection unit 30 selects two of four input portions 71 to 74 in accordance with the switching signal from control unit 40. Then, input selection unit 30 connects the selected two input portions with the first and second output terminals 76, 77, respectively, and thereby supplies image signals received by the input portions to the first and second scaling units 32, 34 via the first and second output terminals 76, 77, respectively.

The first scaling unit 32 performs processing for converting a resolution of an image represented by the image signal, in accordance with an instruction from control unit 40, using a resolution of a display unit (liquid crystal panel) in a single-screen display mode causing the display unit to display an image based on a single image signal as a reference (hereinafter referred to as a “reference display size”), in response to a preset desired size not more than the reference display size.

Further, when projector 1 is switched from the single-screen display mode to a dual-screen display mode, the first scaling unit 32 performs processing for converting the resolution of the image represented by the image signal, in accordance with an instruction from control unit 40, in response to a display size per screen. By the resolution conversion processing, the first scaling unit 32 generates image data representing an image for display having a resolution not more than the resolution of the display unit. The generated image data is supplied to the first image adjusting unit 42.

The second scaling unit 34 performs processing for converting a resolution of an image represented by the image signal, in accordance with an instruction from control unit 40, in response to a preset desired size not more than the reference display size. Further, when projector 1 is switched from the single-screen display mode to the dual-screen display mode, the second scaling unit 34 performs processing for converting the resolution of the image represented by the image signal, in accordance with an instruction from control unit 40, in response to a display size per screen. By the resolution conversion processing, the second scaling unit 34 generates image data representing an image for display having a resolution not more than the resolution of the display unit. The generated image data is supplied to the second image adjusting unit 44.

When the first image adjusting unit 42 receives the image data from the first scaling unit 32, the first image adjusting unit 42 adjusts a display manner of the image based on the image data, in accordance with an instruction from control unit 40. The display manner of an image adjusted by the first image adjusting unit 42 includes displayed image quality of an image. The first image adjusting unit 42 adjusts displayed image quality of an image by adjusting at least one parameter among contour, brightness, concentration, hue, saturation, and contrast of image data.

When the second image adjusting unit 44 receives the image data from the second scaling unit 34, the second image adjusting unit 44 adjusts a display manner of the image based on the image data, in accordance with an instruction from control unit 40. The display manner of an image adjusted by the second image adjusting unit 44 includes displayed image quality of an image. The second image adjusting unit 44 adjusts displayed image quality of an image by adjusting at least one parameter among contour, brightness, concentration, hue, saturation, and contrast of image data.

The image data in which displayed image qualities of images are adjusted by the first image adjusting unit 42 and the second image adjusting unit 44 are supplied to synthesizing unit 46. During execution of the dual-screen display mode, synthesizing unit 46 synthesizes a digital image signal for one frame to be displayed on projection screen SC, based on the supplied two image data. The image signal for one frame obtained by synthesis is converted into an analog signal by a DAC (Digital Analog Converter) not shown. Synthesizing unit 46 outputs the converted signal to liquid crystal display drive unit 50.

In addition, synthesizing unit 46 has an OSD function synthesizing an image input from OSD memory 62 with an image represented by an image signal. Synthesizing unit 46 stores synthesized image data per frame in a frame memory not shown, and outputs the synthesized image data per frame to liquid crystal display drive unit 50. If image data to be synthesized is not input from OSD memory 62, synthesizing unit 46 directly outputs an image signal for one frame to liquid crystal display drive unit 50.

OSD memory 62 is a nonvolatile memory, and stores screens representing manipulation states of projector 1 used for OSD, various character patterns, and the like.

Liquid crystal display drive unit 50, optical system 52, and a lamp (not shown) correspond to a “display unit” for displaying an image on projection screen SC under the control of control unit 40 in accordance with an image signal supplied from the DAC.

An operation of the display unit will be described. The lamp as an illumination apparatus includes, for example, an extra high pressure mercury lamp, a metal halide lamp, and a xenon lamp. The lamp is removably attached to projector 1 via a connector. Substantially parallel light is emitted from the lamp to liquid crystal display drive unit 50.

Liquid crystal display drive unit 50 includes an optical system including a lens and a prism not shown, and R, G, and B liquid crystal panels. In liquid crystal display drive unit 50, the light from the lamp passing through an inside lens system not shown enters the R, G, and B liquid crystal panels such that uniform light amount distribution is obtained. Of the light entering through the lens system, light in a blue wavelength band (hereinafter referred to as “B light”), light in a red wavelength band (hereinafter referred to as “R light”), and light in a green wavelength band (hereinafter referred to as “G light”) enter the R, G, and B liquid crystal panels, respectively, as substantially parallel light. The liquid crystal panels are driven in accordance with image signals corresponding to R, G, and B supplied from synthesizing unit 46, and modulate the light in accordance with drive states thereof. The R light, G light, and B light modulated by the liquid crystal panels are color-synthesized by a dichroic prism, and thereafter projected on projection screen SC in an enlarged manner by a projection lens. The projection lens includes a lens group for forming an image of the projected light on projection screen SC, and an actuator for adjusting a zoom state and a focus state of the projection image by changing a portion of the lens group in an optical axis direction.

Control unit 40 is a CPU (Central Processing Unit). Control unit 40 exchanges signals with each unit via a bus line not shown, and controls an operation of each unit in line with a manipulation signal from manipulation accepting unit 64.

Storage unit 60 is configured, for example, with a data-rewritable nonvolatile memory such as a flash memory. Storage unit 60 stores various control programs for instructing and controlling the operation of projector 1, and the like. It is to be noted that the control programs include a “highlighted display program” as a program for displaying a specific image in a highlighted manner when providing explanations of projection images.

If a manipulation is performed on the manipulation unit or remote controller 4, manipulation accepting unit 64 accepts the manipulation and sends a manipulation signal serving as a trigger for various operations to control unit 40. The manipulation signal transmitted from the manipulation unit or remote controller 4 is input to control unit 40 via manipulation accepting unit 64, and corresponding various processings are performed.

As one of the processings, projector 1 in accordance with the present embodiment has the “dual-screen display mode” selecting two image signals from among the image signals input from the plurality of input terminals of input unit 9, respectively, and displaying two images based on the two image signals, respectively, within one screen, as a mode for displaying an image based on an image signal.

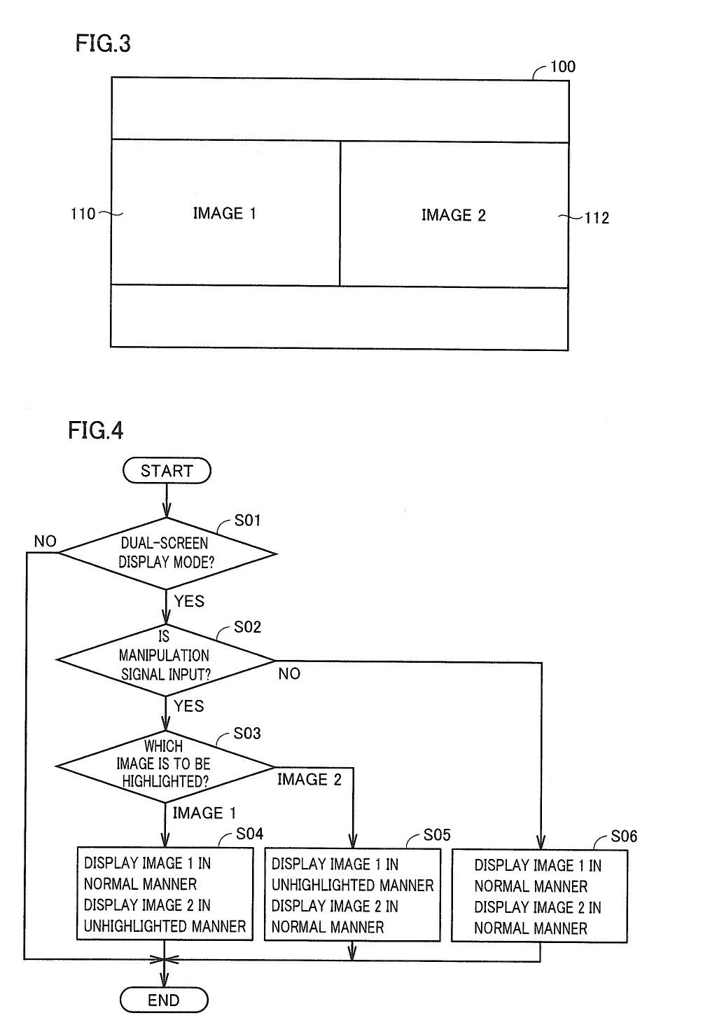

FIG. 3 is a view illustrating an example of display images displayed by projector 1 when the dual-screen display mode is performed.

Referring to FIG. 3, when the dual-screen display mode is performed, two images (corresponding to an image 1 and an image 2 in the drawing) based on two image signals, respectively, are simultaneously displayed in a display region 100 of the display unit (liquid crystal panel). It is assumed that, in the drawing, a display region 110 displaying image 1 and a display region 112 displaying image 2 are displayed to be arranged side by side, and have the same size.

The arrangement of the display regions displaying two image signals is not limited to a laterally aligned manner as shown in FIG. 3, and the display regions may be arranged in a vertically aligned manner. In addition, the display regions may have the same size as shown in FIG. 3, and may also have different sizes.

In the dual-screen display mode, synthesizing unit 46 (FIG. 2) performs synthesis processing on the image data output from the first image adjusting unit 42 and the second image adjusting unit 44 such that the two images are arranged in a predetermined layout shown in FIG. 3. Specifically, synthesizing unit 46 performs synthesis processing such that the image based on the image data output from the first image adjusting unit 42 is displayed in display region 110 of FIG. 3, and the image based on the image data output from the second image adjusting unit 44 is displayed in display region 112 of FIG. 3. That is, the first image adjusting unit 42 can adjust the display manner of the image to be displayed in display region 110 (image 1), and the second image adjusting unit 44 can adjust the display manner of the image to be displayed in display region 112 (image 2).

Here, when a presenter makes a presentation using images displayed in the dual-screen display mode, there are often scenes where the presenter desires viewers to focus attention on one of the two images. In such a scene, projector 1 in accordance with the present embodiment 1 performs highlighted display for clearly distinguishing one image to receive attention from the other image. Hereinafter, an operation of projector 1 when performing the highlighted display will be described with reference to a drawing.

(Operation of Projector)

FIG. 4 is a flowchart for illustrating an operation of projector 1. When an image signal is input to input unit 9, control unit 40 gives instructions to the units of projector 1 shown in FIG. 2 to cause an image based on the input image signal to be displayed, and operates in accordance with a processing flow of FIG. 4.

Referring to FIG. 4, in step S01, control unit 40 determines whether or not projector 1 is set to the dual-screen display mode. If projector 1 is not set to the dual-screen display mode (NO in step S01), control unit 40 causes an image based on a single image signal selected from a plurality of image signals input to input unit 9 to be singularly displayed on a substantially entire screen (hereinafter also referred to as single-screen display) in accordance with a separately set processing flow, and terminates processing.

On the other hand, if projector 1 is set to the dual-screen display mode (YES in step S01), control unit 40 determines whether or not a manipulation signal related to the highlighted display is input to manipulation accepting unit 64 (step S02). The manipulation signal related to the highlighted display is a signal emitted from remote controller 4 or the manipulation unit to manipulation accepting unit 64 when a user of projector 1 (the presenter) performs a manipulation to select one of the two images within display region 100 using remote controller 4 or the manipulation unit. The manipulation signal designates the one image selected by the user.

If the manipulation signal related to the highlighted display is not input (NO in step S02), control unit 40 gives instructions to the first image adjusting unit 42 and the second image adjusting unit 44 to cause image 1 and image 2 to be displayed in the same manner (step S06). Hereinafter, the display manner on this occasion will also be referred to as “normal display”.

In contrast, if the manipulation signal related to the highlighted display is input to manipulation accepting unit 64 (YES in step S02), control unit 40 determines which of the two images (image 1 and image 2 of FIG. 3) is selected as an image to be highlighted, that is, as an image to receive attention of the viewers, based on the manipulation signal (step S03).

When control unit 40 determines the image to be highlighted, control unit 40 causes the first image adjusting unit 42 and the second image adjusting unit 44 to perform processing to differentiate display manners of the images to be displayed, between the image to be highlighted and the other image.

Specifically, if it is determined in step S03 that image 1 is selected as the image to be highlighted, control unit 40 causes image 1 to be displayed in the display manner for the normal display, and causes image 2 to be displayed with displayed image quality lower than that for the normal display (step S04). Hereinafter, the display manner on this occasion will also be referred to as “unhighlighted display”. Thereby, visibility of image 2 displayed in an unhighlighted manner is lower than visibility of image 2 displayed in a normal manner.

On the other hand, if it is determined in step S03 that image 2 is selected as the image to be highlighted, control unit 40 causes image 2 to be displayed in the display manner for the normal display, and causes image 1 to be displayed in an unhighlighted manner (step S05). Thereby, visibility of image 1 displayed in the unhighlighted manner is lower than visibility of image 1 displayed in the normal manner.

As described above, when performing the highlighted display, the projector in accordance with the present embodiment 1 performs processing to lower displayed image quality on another image of a plurality of images other than a desired image, and thereby intentionally lowers visibility of the other image. On the other hand, displayed image quality of the desired image, which is not subjected to the processing to lower displayed image quality, is maintained. As a result, visibility of the desired image is improved within the display region, and thus the desired image can be displayed in a substantially highlighted manner.

According to the projector in accordance with the present embodiment 1, with such a configuration, in a scene where the presenter desires the viewers to focus attention on one of a plurality of images, the presenter can cause a desired image to be displayed in a highlighted manner only by selecting the desired image using the remote controller or the manipulation unit. Therefore, since the presenter does not have to point to the desired image using a laser pointer or a pointing bar, convenience of the presenter when making a presentation is improved.

Further, since the display manners are differentiated between the desired image and an image other than the desired image within the display region, the desired image can be clearly distinguished from the other image. In particular, since visibility of the desired image is improved by intentionally lowering visibility of the other image, the viewers can be reliably caused to focus attention on the desired image.

(As to Unhighlighted Display)

Next, the unhighlighted display of an image performed by the projector in accordance with the present embodiment 1 will be described with reference to a drawing.

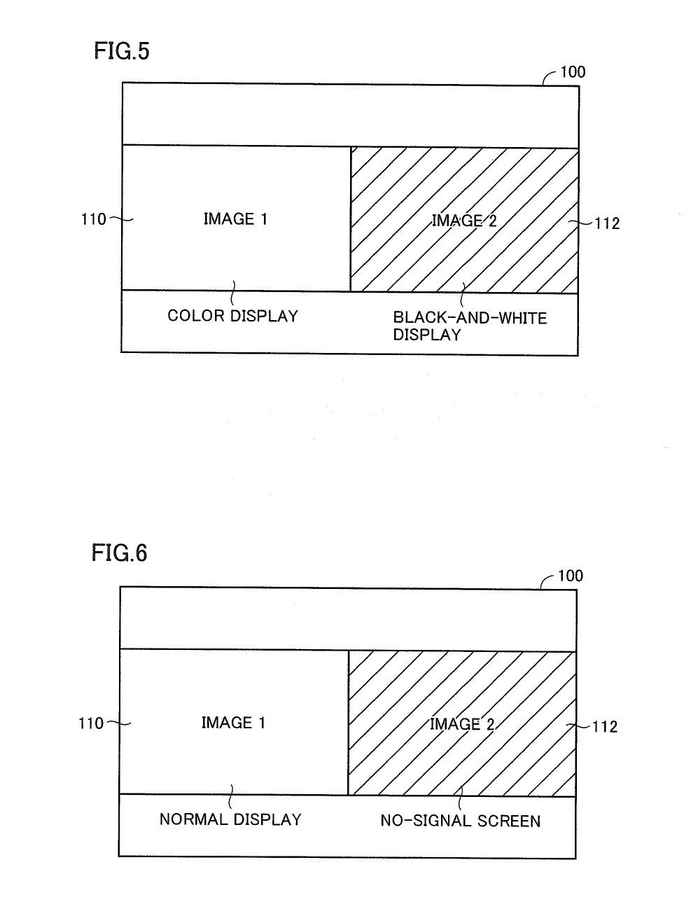

FIG. 5 is a view illustrating an example of the display images in a state where image 2 is displayed in an unhighlighted manner. The drawing assumes a case where the presenter desires the viewers to focus attention on image 1 in a state where two images (image 1 and image 2) are displayed in display regions 110, 112, respectively (a dual-screen display state).

In such a case, projector 1 performs image processing for causing image 2 to be displayed in an unhighlighted manner. As the image processing, if both image 1 and image 2 are color images, only image 2 is converted from the color image to a black-and-white (monochrome) image. Specifically, if control unit 40 detects that a manipulation to select image 1 is performed in the dual-screen display state, control unit 40 causes the second image adjusting unit 44 to convert the color image into a black-and-white image. For example, the second image adjusting unit 44 extracts only Y data from image data input from the second scaling unit 34 by performing RGB to YCbCr conversion on the image data. Thus, the black-and-white image corresponding to a portion where data is present is generated by deleting color information from the image data.

FIG. 6 is a view illustrating another example of the display images in the state where image 2 is displayed in an unhighlighted manner. The drawing assumes a case where the presenter desires the viewers to focus attention on image 1, as in the example of FIG. 5.

As processing for causing image 2 to be displayed in an unhighlighted manner, projector 1 switches image 2 from an original image to, for example, a solid blue screen (hereinafter also referred to as a “no-signal screen”). Specifically, if control unit 40 detects that a manipulation to select image 1 is performed in the dual-screen display state, control unit 40 stops output of the image data from the second image adjusting unit 44 to synthesizing unit 46. Thereby, only the image data from the first image adjusting unit 42 is supplied to synthesizing unit 46. When synthesizing unit 46 reads image data representing the no-signal screen from OSD memory 62, synthesizing unit 46 synthesizes an image signal for one frame to be displayed on the projection screen based on these two image data.

As described above, in the example of FIG. 6, the state of image 2 other than desired image 1 is switched from a display state to a non-display state. As a result, only image 1 is displayed in display region 100. Therefore, the viewers can be reliably caused to focus attention on image 1.

FIG. 7 is a view illustrating another example of the display images in the state where image 2 is displayed in an unhighlighted manner. The drawing assumes a case where the presenter desires the viewers to focus attention on image 1, as in the example of FIG. 5.

As processing for causing image 2 to be displayed in an unhighlighted manner, projector 1 lowers contrast of image 2. Specifically, if control unit 40 detects that a manipulation to select image 1 is performed in the dual-screen display state, control unit 40 causes the second image adjusting unit 44 to lower the contrast of image 2. Thereby, image 2 looks hazy whereas image 1 is clearly visible within display region 100. Therefore, the viewers can be reliably caused to focus attention on image 1.

The processing for causing image 2 to be displayed in an unhighlighted manner is not limited to the processings shown in FIGS. 5 to 7. Displayed image quality of image 2 can be lowered by adjusting at least one parameter among contour, brightness, concentration, hue, saturation, and contrast of image data.

For example, the processing for the unhighlighted display further includes processing to lower brightness. By the processing, image 2 looks dark whereas image 1 looks bright within display region 100.

Further, by performing processing to blur the contour of image 2, image 2 looks blurred whereas image 1 is clearly visible within display region 100. Alternatively, by performing processing to lower the saturation of image 2, image 2 is displayed in pale colors whereas image 1 is displayed in bright colors within display region 100.

Furthermore, if the processing to lower the contrast of image 2 is combined with the processing to lower the brightness of the image, visibility of image 2 within display region 100 is further lowered, and thus the viewers can be caused to focus attention on image 1 more reliably.

### Embodiment 2

Since a configuration and a basic operation of a projector in accordance with Embodiment 2 of the present invention are identical to those of projector 1 in accordance with Embodiment 1, the description thereof will not be repeated by using the same reference numerals, and only image processing different from that in Embodiment 1 will now be described.

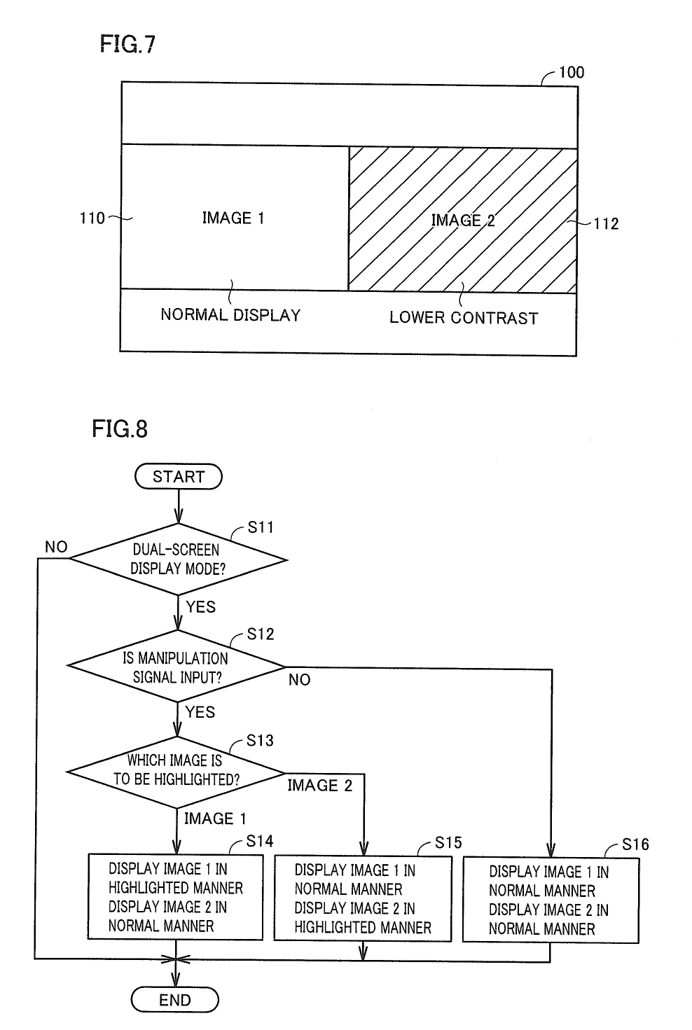

FIG. 8 is a flowchart for illustrating an operation of a projector in accordance with Embodiment 2 of the present invention. When an image signal is input to input unit 9, control unit 40 gives instructions to the units of projector 1 shown in FIG. 2 to cause an image based on the input image signal to be displayed, and operates in accordance with a processing flow of FIG. 8.

Referring to FIG. 8, in step S11, control unit 40 determines whether or not projector 1 is set to the dual-screen display mode. If projector 1 is not set to the dual-screen display mode (NO in step S11), control unit 40 causes an image based on a single image signal selected from a plurality of image signals input to input unit 9 to be displayed in the single-screen display state in accordance with a separately set processing flow, and terminates processing.

On the other hand, if projector 1 is set to the dual-screen display mode (YES in step S11), control unit 40 determines whether or not a manipulation signal related to the highlighted display is input to manipulation accepting unit 64 (step S12). If the manipulation signal related to the highlighted display is not input (NO in step S12), control unit 40 give instructions to the first image adjusting unit 42 and the second image adjusting unit 44 to cause image 1 and image 2 to be displayed in the normal manner (step S16).

In contrast, if the manipulation signal related to the highlighted display is input to manipulation accepting unit 64 (YES in step S12), control unit 40 determines which of the two images (image 1 and image 2 of FIG. 3) is selected as an image to be highlighted, that is, as an image to receive attention of the viewers, based on the manipulation signal (step S13).

When control unit 40 determines the image to be highlighted, control unit 40 causes the first image adjusting unit 42 and the second image adjusting unit 44 to perform processing to differentiate display manners of the images to be displayed, between the image to be highlighted and the other image.

Specifically, if it is determined in step S13 that image 1 is selected as the image to be highlighted, control unit 40 causes image 2 to be displayed in the display manner for the normal display, and causes image 1 to be displayed in a highlighted manner (step S14). On the other hand, if it is determined in step S13 that image 2 is selected as the image to be highlighted, control unit 40 causes image 1 to be displayed in the display manner for the normal display, and causes image 2 to be displayed in a highlighted manner (step S15).

As described above, when performing the highlighted display, the projector in accordance with the present embodiment 2 performs processing to cause an image to be highlighted to be displayed in a highlighted manner within display region 100. That is, the projector in accordance with the present embodiment 2 is common to the projector in accordance with the previous embodiment 1 in that display manners are differentiated between image 1 and image 2 within display region 100. On the other hand, the projector in accordance with the present embodiment 2 is different from the projector in accordance with the previous embodiment 1 in that the former projector causes an image to be highlighted to be displayed in a directly highlighted manner, whereas the latter projector causes an image other than an image to be highlighted to be displayed in an unhighlighted manner.

According to the projector in accordance with the present embodiment 2, with such a configuration, in a scene where the presenter desires the viewers to focus attention on one of a plurality of images, the presenter can cause a desired image to be displayed in a highlighted manner only by selecting the desired image using the remote controller or the manipulation unit. As a result, convenience of the presenter when making a presentation is improved, and, by displaying the desired image in the highlighted manner, the presenter can reliably cause the viewers to focus attention on the desired image.

(As to Highlighted Display)

Next, the highlighted display of an image performed by the projector in accordance with the present embodiment 2 will be described with reference to a drawing.

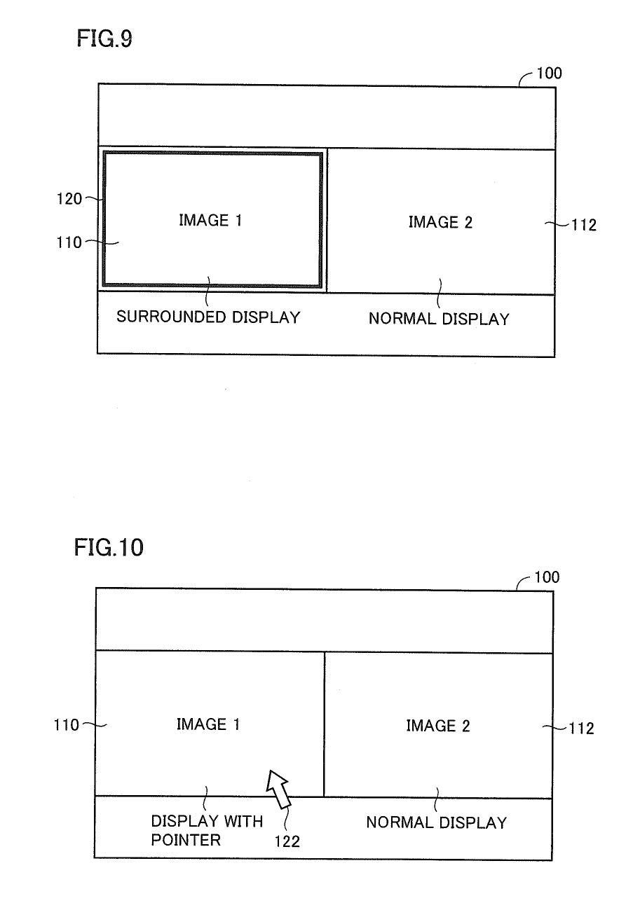

FIG. 9 is a view illustrating an example of the display images in a state where image 1 is displayed in a highlighted manner. The drawing assumes a case where the presenter desires the viewers to focus attention on image 1 in a state where two images (image 1 and image 2) are displayed in display regions 110, 112, respectively (the dual-screen display state).

In such a case, projector 1 performs image processing for causing image 1 to be displayed in a highlighted manner. As the image processing, projector 1 causes an image of a frame surrounding image 1 to be synthesized with image 1. Specifically, if control unit 40 detects that a manipulation to select image 1 is performed in the dual-screen display state, control unit 40 causes synthesizing unit 46 to generate an image of a frame that fits in display region 110 for image 1, and synthesize the image of the frame such that it is displayed to surround display region 110.

As described above, in the example of FIG. 9, by displaying desired image 1 in a state surrounded by a frame, the viewers can be caused to focus attention on image 1.

FIG. 10 is a view illustrating another example of the display images in the state where image 1 is displayed in a highlighted manner. The drawing assumes a case where the presenter desires the viewers to focus attention on image 1, as in the example of FIG. 9.

As processing for causing image 1 to be displayed in a highlighted manner, projector 1 synthesizes a pointer image pointing to image 1. Specifically, if control unit 40 detects that a manipulation to select image 1 is performed in the dual-screen display state, control unit 40 causes synthesizing unit 46 to generate a pointer image and synthesize the pointer image such that it is displayed to be located on display region 110.

The processing for causing image 1 to be displayed in a highlighted manner is not limited to the processings shown in FIGS. 9 and 10. Image 1 can be highlighted by adjusting at least one parameter among contour, brightness, concentration, hue, saturation, and contrast of image data. For example, image 1 may be highlighted by being colored in an eye-catching color.

### Embodiment 3

Since a configuration and a basic operation of a projector in accordance with Embodiment 3 of the present invention are identical to those of projector 1 in accordance with Embodiment 1, the description thereof will not be repeated by using the same reference numerals, and only image processing different from that in Embodiment 1 will now be described.

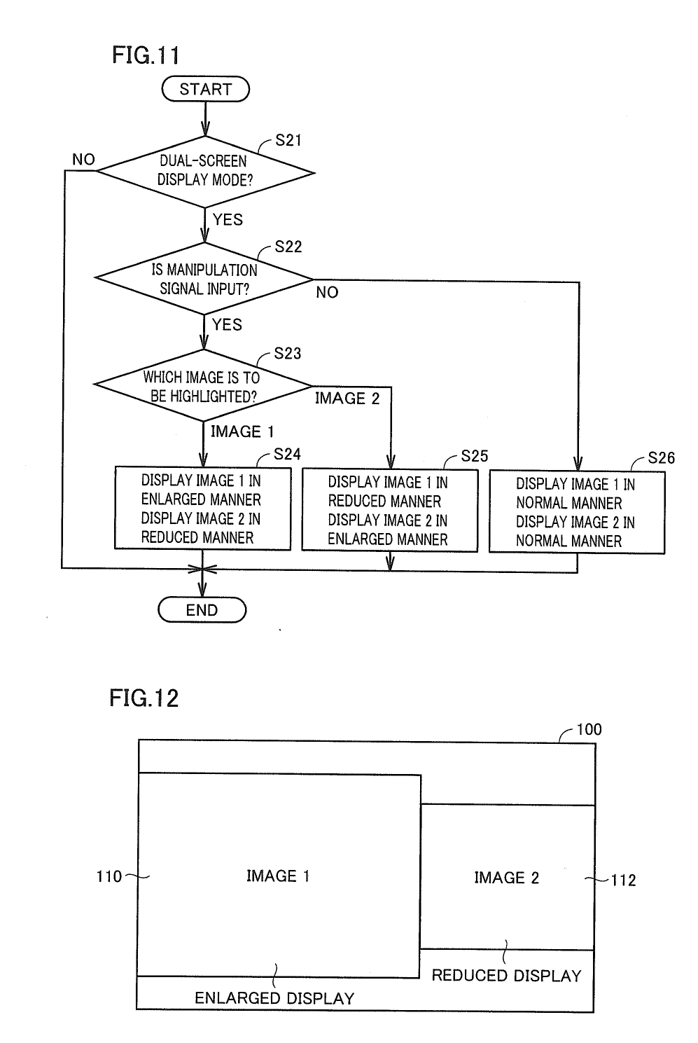

FIG. 11 is a flowchart for illustrating an operation of a projector in accordance with Embodiment 3 of the present invention. When an image signal is input to input unit 9, control unit 40 gives instructions to the units of projector 1 shown in FIG. 2 to cause an image based on the input image signal to be displayed, and operates in accordance with a processing flow of FIG. 11.

Referring to FIG. 11, in step S21, control unit 40 determines whether or not projector 1 is set to the dual-screen display mode. If projector 1 is not set to the dual-screen display mode (NO in step S21), control unit 40 causes an image based on a single image signal selected from a plurality of image signals input to input unit 9 to be displayed in the single-screen display state in accordance with a separately set processing flow, and terminates processing.

On the other hand, if projector 1 is set to the dual-screen display mode (YES in step S21), control unit 40 determines whether or not a manipulation signal related to the highlighted display is input to manipulation accepting unit 64 (step S22). If the manipulation signal related to the highlighted display is not input (NO in step S22), control unit 40 gives instructions to the first image adjusting unit 42 and the second image adjusting unit 44 to cause image 1 and image 2 to be displayed in the normal manner (step S26).

In contrast, if the manipulation signal related to the highlighted display is input to manipulation accepting unit 64 (YES in step S22), control unit 40 determines which of the two images (image 1 and image 2 of FIG. 3) is selected as an image to be highlighted, that is, as an image to receive attention of the viewers, based on the manipulation signal (step S23).

When control unit 40 determines the image to be highlighted, control unit 40 causes the first image adjusting unit 42 and the second image adjusting unit 44 to perform processing to differentiate display manners of the images to be displayed, between the image to be highlighted and the other image.

Specifically, if it is determined in step S23 that image 1 is selected as the image to be highlighted, control unit 40 causes image 2 to be displayed in a display manner with a display size thereof being reduced when compared with a display size for the normal display, and causes image 1 to be displayed in a display manner with a display size thereof being enlarged when compared with a display size for the normal display (step S24). On the other hand, if it is determined in step S23 that image 2 is selected as the image to be highlighted, control unit 40 causes image 1 to be displayed in a display manner with the display size thereof being reduced when compared with the display size for the normal display, and causes image 2 to be displayed in a display manner with the display size thereof being enlarged when compared with the display size for the normal display (step S25).

FIG. 12 is a view illustrating an example of the display images in a state where image 1 is displayed in a highlighted manner. The drawing assumes a case where the presenter desires the viewers to focus attention on image 1 in a state where two images (image 1 and image 2) are displayed in display regions 110, 112, respectively (the dual-screen display state).

In the example of FIG. 12, processing to cause image 1 to be displayed in an enlarged manner and processing to cause image 2 to be displayed in a reduced manner are simultaneously performed. Specifically, if control unit 40 detects that a manipulation to select image 1 is performed in the dual-screen display state, control unit 40 instructs the first scaling unit 32 to perform the resolution conversion processing such that the display size of image 1 becomes equal to a predetermined display size for enlarged display. Further, control unit 40 instructs the second scaling unit 34 to perform the resolution conversion processing such that the display size of image 2 becomes equal to a predetermined display size for reduced display.

As described above, when performing the highlighted display, the projector in accordance with the present embodiment 3 performs processing to differentiate display sizes between an image to be highlighted and the other image. Although the example of FIG. 12 is configured such that processing to cause the image to be highlighted to be displayed in an enlarged manner and processing to cause the other image to be displayed in a reduced manner are performed concurrently, only either one processing may be performed. For example, image 2 may be displayed in an unhighlighted manner by displaying image 2 in a reduced manner without changing the display size of image 1. Alternatively, image 1 may be displayed in a highlighted manner by displaying image 1 in an enlarged manner without changing the display size of image 2.

According to the projector in accordance with the present embodiment 3, with such a configuration, in a scene where the presenter desires the viewers to focus attention on one of a plurality of images, the presenter can cause a desired image to be displayed in a highlighted manner only by selecting the desired image using the remote controller or the manipulation unit. As a result, convenience of the presenter when making a presentation is improved, and the presenter can reliably cause the viewers to focus attention on the desired image.

Although the embodiments described above have described manners of switching image signals input from a plurality of image sources in dual-screen display, the present invention is also similarly applicable to multi-screen display simultaneously displaying not less than three images. In this case, in response to selection of one of not less than three images within the display region, the above processing to differentiate display manners between the one image and the other images is performed.

Although the embodiments described above have individually described processing to differentiate displayed image qualities and processing to differentiate display sizes as the processing to differentiate display manners between a desired image and the other image, the scope of the present invention is not limited thereto, and the processings can be applied in combination.

Further, although the embodiments described above have individually described processing to cause a desired image to be displayed in a highlighted manner and processing to cause the other image to be displayed in an unhighlighted manner, these two processings can be applied in combination.

Although a liquid crystal projector has been employed as the projector in Embodiments 1 to 3 described above, the present invention is not limited thereto. For example, the technique of the present invention may be employed in a projector of other type such as a DLP (Digital Light Processing) (registered trademark) projector.

It should be understood that the embodiments disclosed herein are illustrative and non-restrictive in every respect. The scope of the present invention is defined by the scope of the claims, rather than the description above, and is intended to include any modifications within the scope and meaning equivalent to the scope of the claims.

What is claimed is:

1. An image display apparatus which displays an image based on an image signal, comprising:
an input unit to which a plurality of image signals are input from a plurality of image signal supply apparatuses;
a display unit which displays a plurality of images based on said plurality of image signals, respectively, in a plurality of display regions, respectively; and
a control unit which controls said display unit, when not less than one display region is selected from among said plurality of display regions, such that display manners of the images to be displayed are differentiated between said selected display region and a remaining display region of said plurality of display regions other than said selected display region.

2. The image display apparatus according to claim 1, wherein said control unit causes said display manners to be differentiated by lowering image quality of the image to be displayed in said remaining display region.

3. The image display apparatus according to claim 1, wherein said control unit causes said display manners to be differentiated by not displaying the image in said remaining display region.

4. The image display apparatus according to claim 1, wherein said control unit causes said display manners to be differentiated by highlighting the image to be displayed in said selected display region.

5. The image display apparatus according to claim 4, wherein said control unit causes an image for specifying said selected display region to be synthesized with the image to be displayed in said selected display region.

6. The image display apparatus according to claim 1, wherein said control unit causes said display manners to be differentiated by differentiating display sizes between the image to be displayed in said selected display region and the image to be displayed in said remaining display region.
